(19) United States
(12) Patent Application Publication
(10) Pub. No.: US 2024/0395999 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/616,281

(22) Filed: Mar. 26, 2024

(30) Foreign Application Priority Data
May 22, 2023 (JP) 2023-083847

(51) Int. Cl. H01M 4/04; H01M 10/04; H01M 50/107

(52) U.S. Cl. CPC H01M 4/0404; H01M 10/0431; H01M 50/107

(57) ABSTRACT

A power storage cell includes a wound electrode assembly which includes: a positive plate (a first electrode); a negative plate (a second electrode); and a separator. The positive plate includes a positive current collector (a first current collector) and a positive electrode mixture layer (a first electrode material layer). The positive current collector has: a positive coated portion (a first coated portion) and a plurality of positive uncoated portions (first uncoated portions) projecting from the positive coated portion on one axial side of the wound electrode assembly. Some of the plurality of positive uncoated portions are disposed side by side, spaced apart from each other in X direction (a winding direction).

### CROSS REFERENCE TO RELATED APPLICATIONS

This nonprovisional application is based on Japanese Patent Application No. 2023-083847 filed on May 22, 2023 with the Japan Patent Office, the entire content of which is hereby incorporated by reference.

### BACKGROUND OF THE DISCLOSURE

### Field of the Disclosure

The present disclosure relates to a power storage cell.

### Description of the Background Art

Japanese Patent No. 4805545 discloses a lithium secondary battery that includes a wound internal electrode assembly which includes a positive metallic foil and a negative metallic foil with a separator in between. The internal electrode assembly is a tabless electrode which includes end portions of the metallic foils (positive, negative) in contact with current collector members (positive, negative). The end portions of the metallic foils project out through between the separators.

### SUMMARY OF THE DISCLOSURE

In the internal electrode assembly disclosed in Japanese Patent No. 4805545, the end portions of the metallic foils in contact with the current collector members project out through between the separators, the separators are therefore covered with such end portions. Due to this, the flow of an electrolyte solution as injected into the wound electrode assembly may be blocked by the end portions, causing the electrolyte solution to less penetrate the separators.

The present disclosure is made to solve the problem, and an object of the present disclosure is to provide a power storage cell that allows an electrolyte solution to efficiently penetrate the separators of the wound electrode assembly.

A power storage cell according to one aspect of the present disclosure includes: a wound electrode assembly which includes a first electrode, a second electrode, and a separator disposed between the first electrode and the second electrode; and a case accommodating the wound electrode assembly. The first electrode includes a first current collector and a first electrode material layer coating a portion of the first current collector and facing the separator in a radial direction of the wound electrode assembly. The first current collector has: a first coated portion that is coated with the first electrode material layer; and a plurality of first uncoated portions that are not coated with the first electrode material layer, the plurality of first uncoated portions being located more to a one axial side of the wound electrode assembly than the first coated portion is. The plurality of first uncoated portions are disposed side by side in a winding direction of the wound electrode assembly. At least some of the plurality of first uncoated portions are disposed side by side, spaced apart from each other in the winding direction.

In the power storage cell according to the aspect of the present disclosure, at least some of the plurality of first uncoated portions are disposed side by side, spaced apart from each other in the winding direction, as described above. This allows the space between the first uncoated portions to be used as a route for injection of an electrolyte solution into the wound electrode assembly. As a result, the electrolyte solution is allowed to efficiently penetrate the separators of the wound electrode assembly.

In the power storage cell according to the aspect, preferably, the wound electrode assembly includes a covered portion that is covered with the plurality of first uncoated portions and an uncovered portion that is not covered with the plurality of first uncoated portions, as viewed from the one axial side. With such a configuration, the uncovered portion can be used as a route for injection of an electrolyte solution into the wound electrode assembly. As a result, the electrolyte solution is allowed to more efficiently penetrate the separators of the wound electrode assembly.

In this case, preferably, the plurality of first uncoated portions are arranged along the radial direction. With such a configuration, the first uncoated portion can be inhibited from preventing the electrolyte solution, when being injected into the wound electrode assembly, from moving in the radial direction, as compared to when the first uncoated portions are arranged in the circumference direction.

In the power storage cell according to the aspect, preferably, a distance, between first uncoated portions, among the plurality of first uncoated portions, which are disposed, spaced apart from each other in the winding direction, gradually increases to a winding end side in the winding direction. With such a configuration, the injection of the electrolyte solution from radially outward (the winding end side) of the wound electrode assembly can be facilitated.

In the power storage cell according to the aspect, preferably, among the plurality of first uncoated portions, first uncoated portions that are on the outer periphery of the wound electrode assembly are disposed side by side, adjacent to each other in the winding direction. With such a configuration, the first uncoated portions can be closely disposed on the outer periphery of the wound electrode assembly.

In the power storage cell according to the aspect, preferably, the second electrode includes a second current collector and a second electrode material layer with which a portion of the second current collector is coated, the second electrode material layer facing the separator in the radial direction. The second current collector has: a second coated portion that is coated with the second electrode material layer; and a plurality of second uncoated portions that are not coated with the second electrode material layer, the plurality of second uncoated portions being located more to the other axial side of the wound electrode assembly than the second coated portion is. The plurality of second uncoated portions are disposed side by side in the winding direction. At least some of the plurality of second uncoated portions are disposed side by side, spaced apart from each other in the winding direction. With such a configuration, the electrolyte solution is allowed to flow through the space between the second uncoated portions from the second electrode side to the separator.

According to the present disclosure, the electrolyte solution is allowed to efficiently penetrate the separators of the wound electrode assembly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a configuration of a power storage cell according to an embodiment.

FIG. 2 is an enlarged partial view of the positive side of the power storage cell of FIG. 1.

FIG. 3 is an enlarged partial view of the negative side of the power storage cell of FIG. 1.

FIG. 4 is a plan view showing a configuration of a positive current collector according to an embodiment.

FIG. 5 is a diagram showing a distance between positive uncoated portions versus locations of the positive uncoated portions in a winding direction.

FIG. 6 is a plan view of a wound electrode assembly according to the embodiment, as viewed from Z1 side.

FIG. 7 is a plan view showing a configuration of a negative current collector according to the embodiment.

FIG. 8 is a diagram showing a distance between negative uncoated portions and locations of the negative uncoated portions in the winding direction.

FIG. 9 is a plan view of the wound electrode assembly according to the embodiment, as viewed from Z2 side.

FIG. 10 is a plan view showing a configuration of the positive current collector according to a variation of the embodiment.

### DESCRIPTION OF THE PREFERRED EMBODIMENTS

Hereinafter, an embodiment according to the present disclosure will be described, with reference to the accompanying drawings. Note that like reference signs are used to refer to like or corresponding parts in the drawings, and the description thereof will not be repeated.

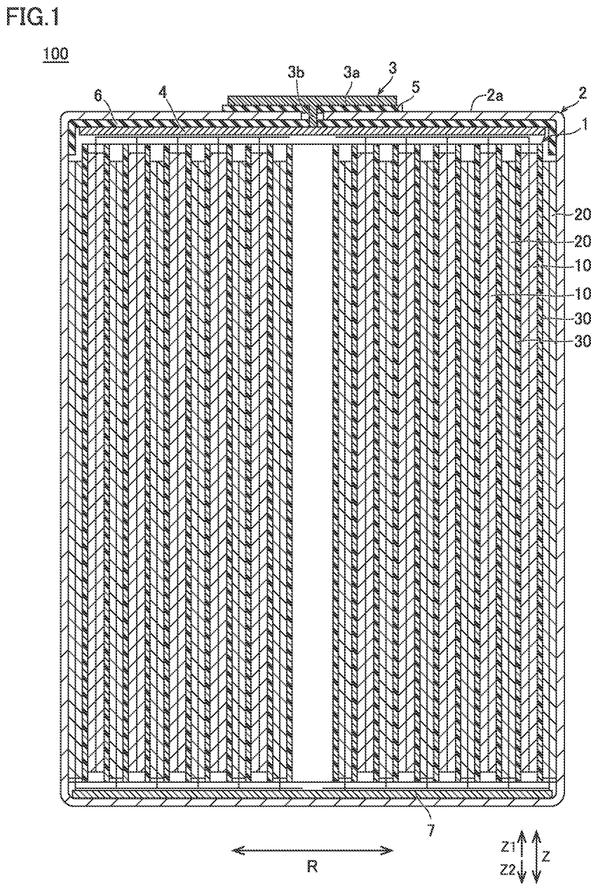

FIG. 1 is a cross-sectional view showing a general configuration of a power storage cell 100 according to an embodiment of the present disclosure. The power storage cell 100 is, for example, a lithium-ion battery that is mounted on a vehicle. Note that the application and type of the power storage cell 100 are not limited thereto.

The power storage cell 100 includes a wound electrode assembly 1, a case 2, a positive terminal 3, a positive current collector plate 4, an external gasket 5, an internal gasket 6, and a negative current collector plate 7.

The wound electrode assembly 1 is accommodated in the case 2. The case 2 has a cylindrical shape. In other words, the power storage cell 100 is a cylindrical battery. Note that the case 2 is formed of copper or aluminum, for example.

The wound electrode assembly 1 includes positive plates 10, negative plates 20, and separators 30. The separator 30 is disposed between the positive plate 10 and the negative plate 20. The separator 30 separates the positive plate 10 and the negative plate 20, while allowing ions (e.g., lithium-ions) to traverse between the positive plate 10 (a positive active material) and the negative plate 20 (a negative active material). The wound electrode assembly 1 is configured of a group of electrode plates in which the positive plate 10 and the negative plate 20 are wound via the separator 30. Note that the positive plate 10 and the negative plate 20 are one example of a “first electrode” and a “second electrode,” respectively, according to the present disclosure.

The positive terminal 3 includes a disk portion 3a and a riveting portion 3b. The riveting portion 3b is connected to the disk portion 3a. The riveting portion 3b extends from the center of the disk portion 3a to Z2 side. Note that the positive terminal 3 is formed of aluminum.

The disk portion 3a is disposed on an upper surface 2a (the Z1-side surface) of the case 2. The upper surface 2a of the case 2 has a through hole 2b. The riveting portion 3b extends from the disk portion 3a, disposed outside the case 2, into the case 2 through the through hole 2b.

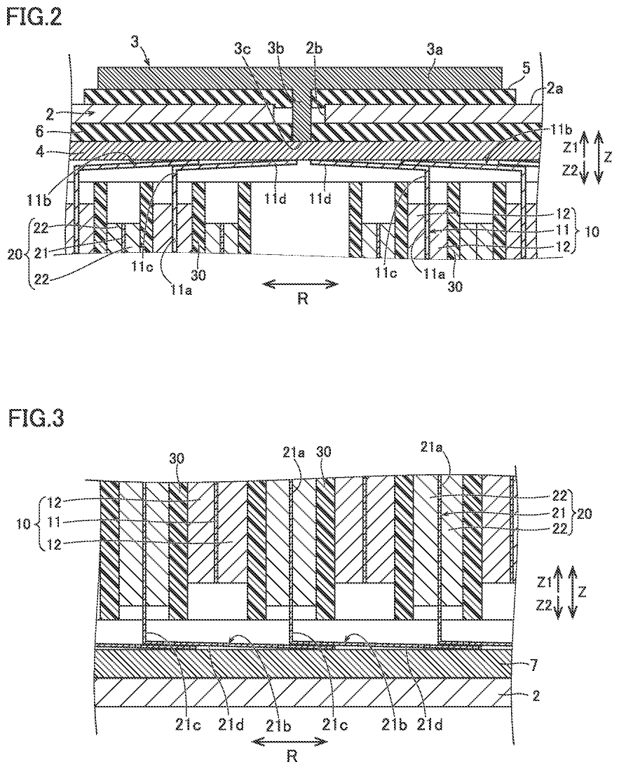

The positive current collector plate 4 is accommodated in the case 2. On Z1 side of the wound electrode assembly 1, the positive current collector plate 4 is welded to a positive uncoated portion 11b (described below) of the positive plate 10. This causes the positive current collector plate 4 to be positively charged. The positive current collector plate 4 is welded to an end 3c (see FIG. 2) of the riveting portion 3b on Z2 side. This causes the positive terminal 3 to be positively charged.

The external gasket 5 is disposed between the disk portion 3a of the positive terminal 3 and the upper surface 2a of the case 2. This electrically insulates the positive terminal 3 from the case 2.

The internal gasket 6 is disposed in the case 2 between the case 2 and the positive current collector plate 4. This electrically insulates the case 2 from the positive current collector plate 4. Note that the riveting portion 3b passes through the internal gasket 6 and is thereby in contact with the positive current collector plate 4.

The negative current collector plate 7 is accommodated in the case 2. On Z2 side of the wound electrode assembly 1, the negative current collector plate 7 is welded to a negative uncoated portion 21b of the negative plate 20 described below. This causes the negative current collector plate 7 to be negatively charged. Note that the negative current collector plate 7 is in contact with the case 2. This causes the case 2 to be negatively charged.

As shown in FIG. 2, the positive plate 10 includes a positive current collector 11 and a positive electrode mixture layer 12. The positive electrode mixture layer 12 is applied to radially (R direction) opposite surfaces of the positive current collector 11. The positive electrode mixture layer 12 faces the separator 30 in R direction. Note that the positive current collector 11 and the positive electrode mixture layer 12 are one example of a “first current collector” and a “first electrode material layer,” respectively, according to the present disclosure.

For example, aluminum is used for the positive current collector 11. The positive electrode mixture layer 12 is formed by coating a surface of the positive current collector 11 with a cathode slurry and drying. The cathode slurry is prepared by mixing the materials (such as a positive active material and a binder) of the positive electrode mixture layer 12 and a solvent. The positive electrode mixture layer 12 is appressed to the separator 30 (see FIG. 1). The positive electrode mixture layer 12 has a thickness greater than or equal to 0.1 μm and less than or equal to 1000 μm, for example.

The positive current collector 11 includes a positive coated portion 11a and multiple positive uncoated portions 11b. The positive coated portion 11a is a portion of the positive current collector 11 that is coated with the positive electrode mixture layer 12. The positive coated portion 11a is sandwiched between the separators 30. Note that the positive coated portion 11a and the positive uncoated portion 11b are one example of a “first coated portion” and a “first uncoated portion,” respectively, according to the present disclosure.

The positive uncoated portions 11b are each located more to Z1 side than the positive coated portion 11a is. Specifically, the positive uncoated portions 11b each project from the positive coated portion 11a to Z1 side. The positive uncoated portions 11b are disposed side by side in the winding direction of the wound electrode assembly 1. Each of the positive uncoated portions 11b is a portion of the positive current collector 11 which is not coated with the positive electrode mixture layer 12. Z1 side is one example of a “one axial side” according to the present disclosure.

The positive uncoated portions 11b each include a portion 11c extending along Z direction and a portion 11d extending along R direction. In other words, the positive uncoated portions 11b are each bent in an L shape. The portions 11d of the positive uncoated portions 11b are each in contact with the positive current collector plate 4. This causes the positive current collector plate 4 to be positively charged. Note that the positive uncoated portion 11b (the portion 11d) is joined to the positive current collector plate 4 by welding.

The positive uncoated portions 11b that are adjacent to each other in R direction are disposed so that the portions 11d thereof partially overlap.

As shown in FIG. 3, the negative plate 20 includes a negative current collector 21 and a negative electrode mixture layer 22. The negative electrode mixture layer 22 is applied to radially (R direction) opposite surfaces of the negative current collector 21. In other words, the negative electrode mixture layers 22 face the separators 30 in R direction. Note that the negative current collector 21 and the negative electrode mixture layer 22 are one example of a “second current collector” and a “second electrode material layer,” respectively, according to the present disclosure.

For example, copper is used for the negative current collector 21. The negative electrode mixture layer 22 is formed by coating a surface of the negative current collector 21 with an anode slurry and drying. The anode slurry is prepared by mixing the materials (such as a negative active material and a binder) of the negative electrode mixture layer 22 and a solvent. The negative electrode mixture layer 22 is appressed to the separator 30. The negative electrode mixture layer 22 has a thickness greater than or equal to 0.1 μm and less than or equal to 1000 μm, for example.

The negative current collector 21 includes a negative coated portion 21a and multiple negative uncoated portions 21b. The negative coated portion 21a is a portion of the negative current collector 21 that is coated with the negative electrode mixture layer 22. The negative coated portion 21a is sandwiched between the separators 30. Note that the negative coated portion 21a and the negative uncoated portion 21b are one example of a “second coated portion” and a “second uncoated portion,” respectively, according to the present disclosure.

The negative uncoated portions 21b are each located more to Z2 side than the negative coated portion 21a is. Specifically, the negative uncoated portions 21b each project from the negative coated portion 21a to Z2 side. The negative uncoated portions 21b are disposed side by side in the winding direction of the wound electrode assembly 1. Note that each of the negative uncoated portions 21b is a portion of the negative current collector 21 which is not coated with the negative electrode mixture layer 22. Z2 side is one example of “the other axial side” according to the present disclosure.

The negative uncoated portions 21b each include a portion 21c extending along Z direction and a portion 21d extending along R direction. In other words, the multiple negative uncoated portions 21b are each bent in an L shape. The portions 21d of the negative uncoated portions 21b are each in contact with the negative current collector plate 7. This causes the negative current collector plate 7 to be negatively charged. Note that the negative uncoated portion 21b (the portion 21d) is joined to the negative current collector plate 7 by welding.

The negative uncoated portions 21b that are adjacent to each other in R direction are disposed so that the portions 21d thereof partially overlap.

Here, with a configuration of a conventional power storage cell, the separators are covered with the uncoated portions, the flow of an electrolyte solution as injected into the wound electrode assembly is, therefore, blocked by the uncoated portions. Due to this, the electrolyte solution may not be allowed to readily penetrate the separators.

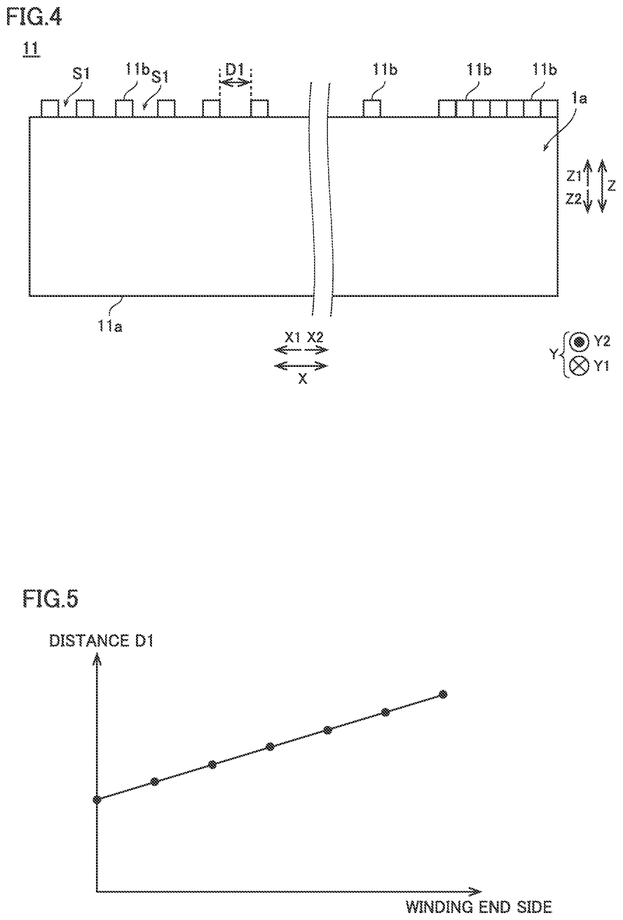

Thus, in the present embodiment, some of the positive uncoated portions 11b are disposed side by side in X direction, spaced apart from each other, as shown in FIG. 4. FIG. 4 is a plan view of the unwound positive current collector 11 as viewed from Y2 side. Note that the positive uncoated portion 11b is not bent in FIG. 4. X direction corresponds to a “winding direction” (R direction of FIG. 1, etc.) according to the present disclosure. Note that X1 direction corresponds to a winding start side in the winding direction, and X2 direction corresponds to a winding end side in the winding direction.

Specifically, the positive uncoated portions 11b, other than the positive uncoated portion 11b corresponding to an outer periphery 1a of the wound electrode assembly 1, are disposed side by side at a distance D1 in X direction. Stated differently, a space S1 is provided between the positive uncoated portions 11b that are adjacent to each other in X direction (except for the positive uncoated portion 11b corresponding to the outer periphery 1a). In the following, the positive uncoated portion 11b, as simply referred to as it is, refers to the positive uncoated portions 11b, excluding the positive uncoated portion 11b corresponding to the outer periphery 1a.

In the present embodiment, the distance D1, between the positive uncoated portions 11b that are disposed, spaced apart from each other in X direction, gradually increases to the winding end side (X2 side) of the winding direction. In other words, the space S1 between the positive uncoated portions 11b gradually increases to the winding end side. For example, the distance D1 may increase linearly to the winding end side (see FIG. 5). Note that the distance D1 may increase quadratically to the winding end side.

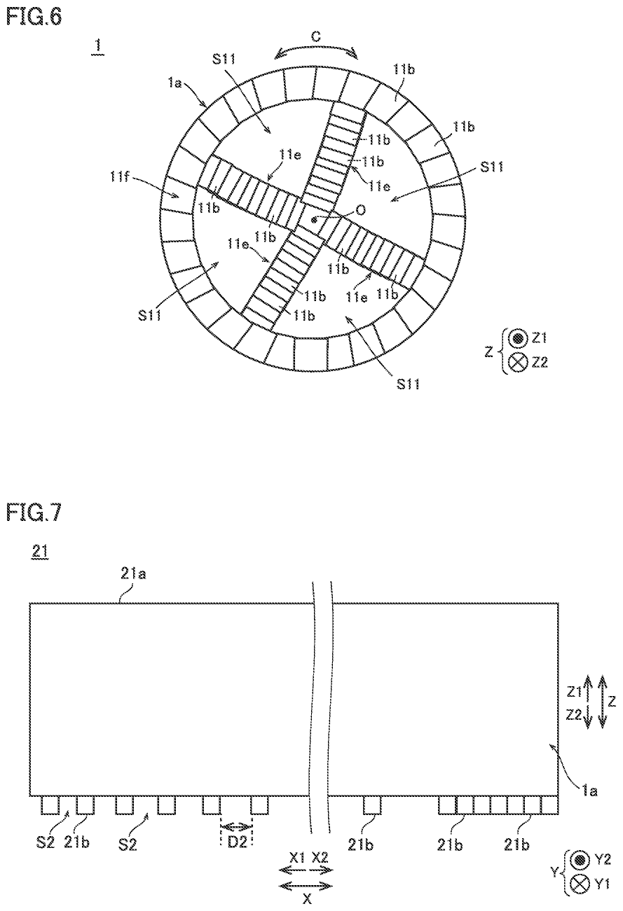

FIG. 6 is a diagram of the wound electrode assembly 1 as viewed from Z1 side (the positive side). As shown in FIG. 6, the positive uncoated portions 11b are arranged along the radial direction (R direction of FIG. 2) of the wound electrode assembly 1, as viewed from Z1 side. In the example shown in FIG. 6, there are four radial arrangement units 11e that are each formed of multiple positive uncoated portions 11b arranged along the radial direction. The four radial arrangement units 11e are each provided extending radially outward from a center O of the wound electrode assembly 1. Note that the radial arrangement unit 11e is one example of a “covered portion” according to the present disclosure.

The radial arrangement units 11e, which are adjacent to each other in the circumference direction (C direction) of the wound electrode assembly 1, are angularly spaced of about 90 degrees. In other words, the radial arrangement units 11e that are adjacent to each other in C direction are arranged orthogonal to each other. This results in the positive uncoated portions 11b being arranged in a cross shape (X shape)) as viewed from Z1 side.

An interstitial area S11 is provided between the radial arrangement units 11e that are adjacent to each other in C direction when the wound electrode assembly 1 is viewed from Z1 side. The interstitial area S11 is formed of accumulation of the spaces S1 (see FIG. 4) between the positive uncoated portions 11b adjacent to each other in the winding direction. Note that the interstitial area S11 corresponds to one example of an “uncovered portion” according to the present disclosure.

Referring to FIGS. 4 and 6, the positive uncoated portions 11b disposed on the outer periphery 1a of the wound electrode assembly 1 are disposed side by side, adjacent to each other in the winding direction. As shown in FIG. 6, as the wound electrode assembly 1 is viewed from Z1 side, the positive uncoated portions 11b disposed on the outer periphery 1a form the outer periphery covering portions 11f covering the outer periphery 1a. In other words, the outer periphery covering portions 11f cover the outer periphery 1a of the wound electrode assembly 1 from Z1 side. The outer periphery covering portions 11f form an annular shape. Note that the outer periphery covering portions 11f are one example of the “covered portion” according to the present disclosure.

The negative uncoated portions 21b are disposed in the same manner as the positive uncoated portions 11b. Specifically, as shown in FIG. 7, some of the negative uncoated portions 21b are disposed side by side, spaced apart from each other in X direction. FIG. 7 is a plan view of the unwound negative current collector 21 as viewed from Y2 side. Note that FIG. 7 shows the negative uncoated portion 21b that is not bent.

The negative uncoated portions 21b, other than the negative uncoated portion 21b corresponding to the outer periphery 1a of the wound electrode assembly 1, are disposed side by side at a distance D2 in X direction. Stated differently, a space S2 is provided between the negative uncoated portions 21b adjacent to each other in X direction (except for the negative uncoated portion 21b corresponding to the outer periphery 1a). Note that the distance D2 may be equal to the distance D1 (see FIG. 4) between the positive uncoated portions 11b. In the following, the negative uncoated portion 21b, as simply referred to as it is, refers to the negative uncoated portions 21b, excluding the negative uncoated portion 21b corresponding to the outer periphery 1a.

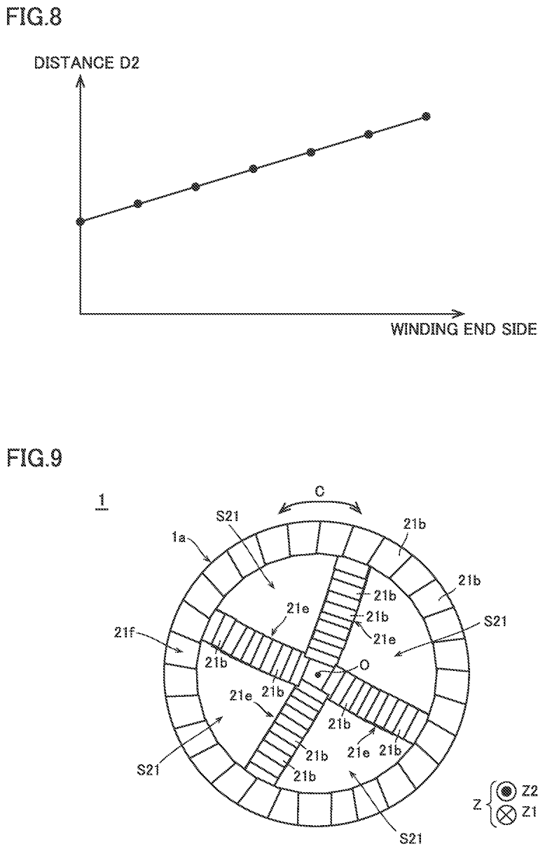

The distance D2, between the negative uncoated portions 21b that are disposed, spaced apart from each other in X direction, gradually increases to the winding end side (X2 side) in the winding direction. In other words, the space S2 between the negative uncoated portions 21b gradually increases to the winding end side. For example, the distance D2 may increase linearly to the winding end side (see FIG. 8). Note that the rate (slope) of the gradual increase of the distance D2 may be equal to the rate (slope) of the gradual increase of the distance D1. The distance D2 may increase quadratically to the winding end side.

FIG. 9 is a diagram of the wound electrode assembly 1 as viewed from Z2 side. As shown in FIG. 9, the negative uncoated portions 21b are arranged along the radial direction (R direction of FIG. 2) of the wound electrode assembly 1, as viewed from Z2 side. In the wound electrode assembly 1, there are four radial arrangement units 21e that are each formed of multiple negative uncoated portions 21b arranged along the radial direction. The four radial arrangement units 11e are each provided extending radially outward from the center O of the wound electrode assembly 1.

The radial arrangement units 21e, which are adjacent to each other in the circumference direction (C direction), are angularly spaced of about 90 degrees. In other words, the radial arrangement units 21e that are adjacent to each other in C direction are arranged orthogonal to each other. This results in the negative uncoated portions 21b being arranged in a cross shape (X shape)) as viewed from Z2 side. Although not shown, it should be noted that the radial arrangement unit 21e may be disposed at a location overlapping the positive-side radial arrangement unit 11e in Z direction.

An interstitial area S21 is provided between the radial arrangement units 21e that are adjacent to each other in C direction when the wound electrode assembly 1 is viewed from Z2 side. The interstitial area S21 is formed of accumulation of the spaces S2 (see FIG. 7) between the negative uncoated portions 21b adjacent to each other in the winding direction.

Referring to FIGS. 7 and 9, the negative uncoated portions 21b disposed on the outer periphery 1a of the wound electrode assembly 1 are disposed side by side, adjacent to each other in the winding direction. As shown in FIG. 9, as the wound electrode assembly 1 is viewed from Z2 side, the negative uncoated portions 21b disposed on the outer periphery 1a form the outer periphery covering portions 21f covering the outer periphery 1a. In other words, the outer periphery covering portions 21f cover the outer periphery 1a of the wound electrode assembly 1 from Z2 side. The outer periphery covering portions 21f form an annular shape.

As described above, in the present embodiment, some of the positive uncoated portion 11b are disposed side by side, spaced apart from each other in the winding direction of the wound electrode assembly 1. This provides the space S1 between the positive uncoated portions 11b. As a result, the interstitial area S11 can be formed, upon formation of the wound electrode assembly 1, as a route for injection of the electrolyte solution. This allows the electrolyte solution to be efficiently penetrate the separators 30. In addition, since the electrolyte solution can be readily injected, prevention of the injection of the electrolyte solution can be inhibited even if the loading (volume) of the electrode active material is increased. As a result, the energy density in the power storage cell 100 can improve by increasing the loading of the electrode active material.

In addition, owing to the formation of the interstitial area S11, if a gas is produced in the power storage cell 100 and the cell internal pressure thereby increases, the gas can be efficiently exhausted through the interstitial area S11 (the cell internal pressure buildup can be relieved).

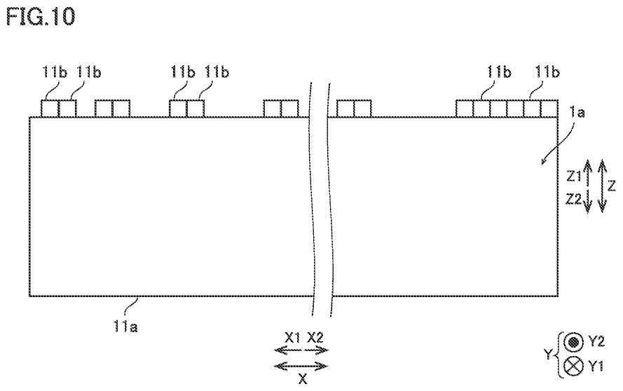

In the above embodiment, the positive uncoated portions 11b, excluding the positive uncoated portion 11b corresponding to the outer periphery 1a, are disposed side by side, spaced apart from each other in the winding direction. However, the present disclosure is not limited thereto. For example, sets, each including multiple (two in FIG. 10) positive uncoated portions 11b adjacent to each other in the winding direction, may be disposed side by side, spaced apart from each other in the winding direction, as shown in FIG. 10. The set, configured of multiple positive uncoated portions 11b, and a single positive uncoated portion 11b may be disposed (alternately), spaced apart from each other in the winding direction. Note that the negative uncoated portions 21b may be arranged in the same manner as the above.

In the above embodiment, the multiple positive uncoated portions 11b, as viewed from Z1 side, are disposed along the radial direction. However, the present disclosure is not limited thereto The positive uncoated portions 11b may be disposed, for example, along the circumference direction, insofar as an area is formed that is not covered with the positive uncoated portions 11b when the wound electrode assembly 1 is viewed from Z1 side. Note that the negative uncoated portions 21b may be arranged in the same manner as the above.

In the above embodiment, the distance D1 between the positive uncoated portions 11b disposed side by side, spaced apart from each other in the winding direction, increases gradually to the winding end side in the winding direction. However, the present disclosure is not limited thereto. For example, the distance D1 may be constant, regardless of the locations of the positive uncoated portions 11b in the winding direction. Alternatively, the distance D1 may reduce gradually to the winding end side. Note that the negative uncoated portions 21b may be arranged in the same manner as the above.

In the above embodiment, the positive uncoated portions 11b disposed on the outer periphery 1a of the wound electrode assembly 1 are disposed side by side, adjacent to each other in the winding direction. However, the present disclosure is not limited thereto. The positive uncoated portions 11b disposed on the outer periphery 1a of the wound electrode assembly 1 may be disposed side by side, spaced apart from each other in the winding direction. Note that the negative uncoated portions 21b may be arranged in the same manner as the above.

In the above embodiment, the positive uncoated portions 11b are disposed side by side, spaced apart from each other in the winding direction, and the negative uncoated portions 21b are disposed side by side, spaced apart from each other in the winding direction. However, the present disclosure is not limited thereto. Only either one of the positive uncoated portions 11b and the negative uncoated portions 21b may be disposed side by side, spaced apart from each other in the winding direction.

Although the embodiment according to the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell, comprising:
a wound electrode assembly which includes a first electrode, a second electrode, and a separator disposed between the first electrode and the second electrode; and
a case accommodating the wound electrode assembly, wherein
the first electrode includes a first current collector and a first electrode material layer coating a portion of the first current collector and facing the separator in a radial direction of the wound electrode assembly, wherein
the first current collector has:
a first coated portion that is coated with the first electrode material layer; and
a plurality of first uncoated portions that are not coated with the first electrode material layer, the plurality of first uncoated portions being located more to a one axial side of the wound electrode assembly than the first coated portion is, wherein
the plurality of first uncoated portions are disposed side by side in a winding direction of the wound electrode assembly, and
at least some of the plurality of first uncoated portions are disposed side by side, spaced apart from each other in the winding direction.

2. The power storage cell according to claim 1, wherein
the wound electrode assembly includes a covered portion that is covered with the plurality of first uncoated portions and an uncovered portion that is not covered with the plurality of first uncoated portions, as viewed from the one axial side.

3. The power storage cell according to claim 2, wherein
the plurality of first uncoated portions are arranged along the radial direction.

4. The power storage cell according to claim 1, wherein
a distance, between first uncoated portions, among the plurality of first uncoated portions, which are disposed, spaced apart from each other in the winding direction, gradually increases to a winding end side in the winding direction.

5. The power storage cell according to claim 1, wherein
among the plurality of first uncoated portions, first uncoated portions that are on the outer periphery of the wound electrode assembly are disposed side by side, adjacent to each other in the winding direction.

6. The power storage cell according to claim 1, wherein
the second electrode includes a second current collector and a second electrode material layer with which a portion of the second current collector is coated, the second electrode material layer facing the separator in the radial direction, wherein
the second current collector has:
a second coated portion that is coated with the second electrode material layer; and
a plurality of second uncoated portions that are not coated with the second electrode material layer, the plurality of second uncoated portions being located more to on the other axial side of the wound electrode assembly than the second coated portion is, wherein
the plurality of second uncoated portions are disposed side by side in the winding direction, and
at least some of the plurality of second uncoated portions are disposed side by side, spaced apart from each other in the winding direction.
